(19) United States
(12) Patent Application Publication
(10) Pub. No.: US 2010/0282915 A1
(43) Pub. Date: Nov. 11, 2010

(54) Unique Device for Extending and Retracting Space Appendices

(76) Inventors: Vincent Barbet, Grasse (FR); Jerome Brossier, Fonsorbes (FR); Cyrille Le Quintrec, Saint Laurent du Var (FR)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/527,361

(22) PCT Filed: Mar. 26, 2008
(86) PCT No.: PCT/EP08/53525

§ 371 Date: Sep. 24, 2009

(30) Foreign Application Priority Data
Mar. 27, 2007 (FR) 07-54049

(51) Int. Cl. B64G 1/66

(52) U.S. Cl. 244/172.6

(57) ABSTRACT

Device for deploying and retracting appendages of space systems comprising at least one support (2) carrying an appendage (1) to be deployed, which is mobile about a rotation spindle (4), and an actuator furnished with a collar (10) driving the said support in rotation by way of a coupling means (9) characterized in that the said coupling means is able in one direction of rotation to cooperate with at least one support (2.1, 2.2, 2.3) so as to drive the said support in rotation and to not cooperate with the said supports in the opposite direction of rotation.

The field of the present invention is that of equipment for space applications, such as for example that for the manufacture of satellites, and in particular devices for the rotational deployment of space appendages.

In space applications it is necessary to be able to orient certain elements of a satellite or of a space vehicle, here dubbed reflectors, such as an antenna, a mast, etc., in a predetermined direction so as, for example, to direct them towards a fixed star, to keep pointing towards a point on the surface of the Earth, or indeed to scan a particular zone on the surface of the Earth or of an arbitrary heavenly body. These reflectors are placed in the folded-back position during satellite launch so as to occupy less room and be integrated into the general form of the launcher. Once in orbit, these reflectors are deployed in order to carry out their function. For some of them it is desirable to be able to reconfigure them in flight, that is to say be able to choose, from among several reflectors, the one which is most suited to the mission in progress. For this purpose several reflectors are on board during launch and it is necessary to be able to deploy a particular reflector, or a set of reflectors and to be able to fold it or them back when they no longer correspond to the mission in progress.

To effect these deployments and retractions a known solution consists of the use of a mechanism dedicated to each reflector. This solution is non-optimal from a cost, mass and bulkiness point of view, but also from the point of view of the complexity of the operations for deploying and retracting the various reflectors.

The aim of the present invention is to remedy these drawbacks by proposing a single mechanism for the deployment and the retraction of the reflectors.

For this purpose, the subject of the invention is a device for deploying and retracting appendages of space systems comprising at least one support carrying an appendage to be deployed, which is mobile about a rotation spindle, and an actuator furnished with a collar driving the said support in rotation by way of a coupling means characterized in that the said coupling means is able in one direction of rotation to cooperate with at least one support so as to drive the said support in rotation and to not cooperate with the said supports in the opposite direction of rotation.

An operator will thus be able to select the reflector that he desires to deploy and perform this deployment with a single mechanism.

In a preferential manner the coupling means is a mobile abutment presenting a face oriented radially with respect to the rotation spindle and a face inclined with respect to the said radial orientation and in which the support carries a catch extending radially under the action of an elastic means so as to interfere with the travel of the mobile abutment.

In an alternative manner the support carries an abutment and the coupling means is a catch presenting a face oriented radially with respect to the rotation spindle and a face inclined with respect to the said radial orientation and extending radially under the action of an elastic means so as to interfere with the travel of the said abutment.

Advantageously the at least one support is permanently urged in rotation towards a fixed abutment in a direction reverse to that of driving by the coupling means.

This configuration avoids the need to provide a control for the return of an appendage to its storage position.

In one embodiment of the invention the fixed abutments and also the supports do not move in the same planes so as not to produce any mechanical interference between the various elements.

In a particular embodiment the appendages or their supports carry at least one partner abutment fixed to a first appendage or support and capable of interfering with the travel of a second appendage or support so as to drive this second appendage or support during the driving of the said first appendage or support by the coupling means.

In another embodiment, the partner abutment can be drawn back under the control of the operator so as to be able either to engage an appendage placed downstream of the selected appendage or not to engage it and to leave it in the storage position.

In another embodiment, the actuator is releasable so as to be able to isolate it from the collar of the actuator, and in which the device comprises a second releasable actuator for affording redundancy to the space system.

The subject of the invention is also a deployment and retraction device for an appendage of a space system comprising at least one support (2) carrying an appendage (1) to be deployed, which is mobile about a rotation spindle (4), and an actuator furnished with a collar (10) driving said support in rotation by way of a coupling means (9)
characterized in that said coupling means is suitable in one direction of rotation for cooperating with the support (2.1, 2.2, 2.3) so as to drive said support in rotation and for not cooperating with said support in the opposite direction of rotation and:
in which the coupling means is a mobile abutment (9) presenting a face oriented radially with respect to the rotation spindle and a face inclined with respect to said radial orientation and in which each support (2) carries a catch (7) extending radially under the action of an elastic means (8) so as to interfere with the travel of the mobile abutment (9);
or in which each support (2) carries an abutment and in which the coupling means (9) is a catch (7) presenting a face oriented radially with respect to the rotation spindle and a face inclined with respect to said radial orientation and extending radially under the action of an elastic means (8) so as to interfere with the travel of said abutment.

The invention will be better understood, and other aims, details, characteristics and advantages thereof will be more clearly apparent in the course of the detailed explanatory description which will follow, of several embodiments of the invention given by way of purely illustrative and nonlimiting examples, with reference to the attached schematic drawings.

In these drawings:

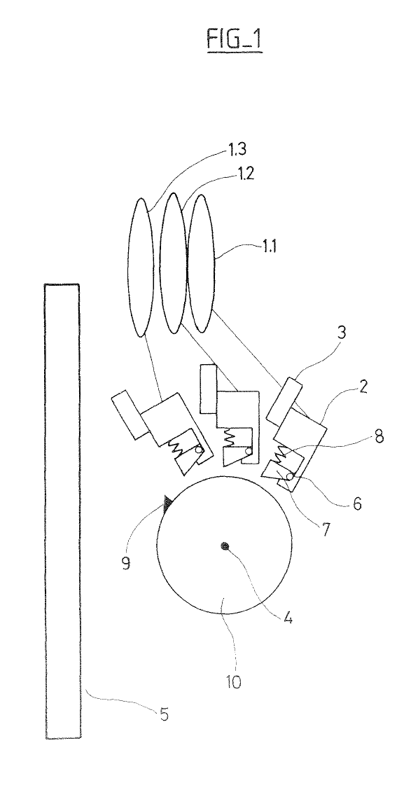

FIG. 1 is a schematic view of a deployment/retraction device according to an embodiment of the invention;

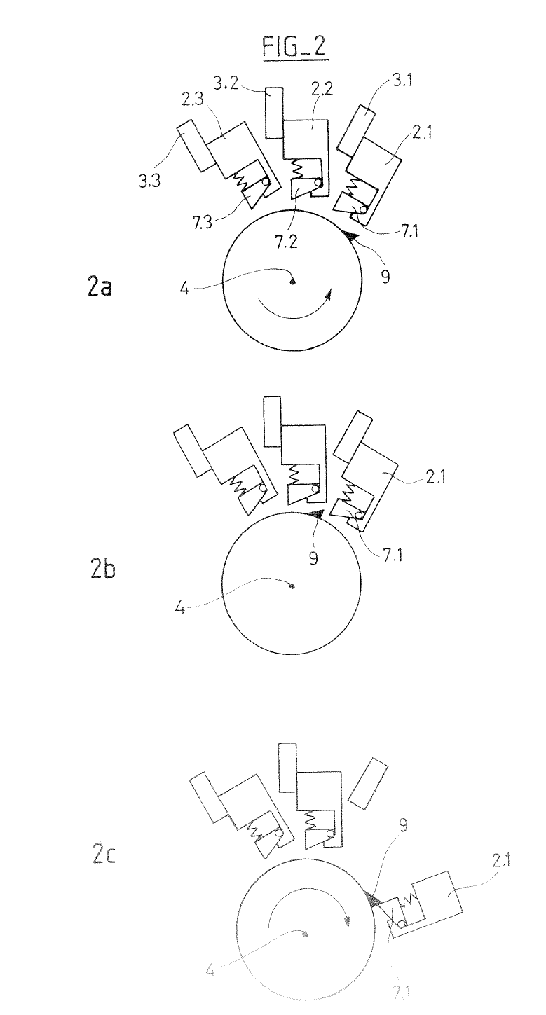

FIG. 2 is a schematic view in three steps of the deployment of a reflector with the aid of a deployment/retraction device according to the invention;

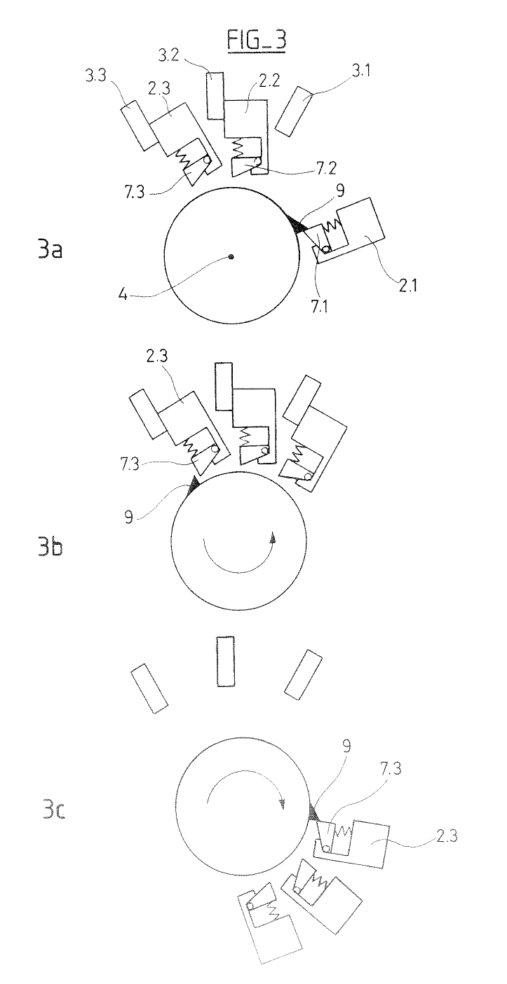

FIG. 3 is a schematic view in three steps of the retracting of a deployed reflector and of the deploying of three reflectors with the aid of a deployment/retraction device according to the invention.

FIG. 1 depicts a deployment and retraction device according to the invention with three deployable appendages 1, such as reflectors (referenced 1.1, 1.2 and 1.3 in FIG. 1), folded back in their storage position for launch. These reflectors are carried by three supports 2, which can be rotated about a rotation spindle 4 and carry a device with a catch 7. In the position of the folded-back reflectors these supports 2 are kept bearing against abutments 3, fixed with respect to the wall of the satellite 5. These supports are kept respectively bearing against their abutment by virtue of restoring mechanisms (not represented), of the torsion spring type, which constantly tend to return the reflectors 1 to their storage position.

Each support 2 is composed of a body serving as buffer against the fixed abutment 3 and of an arm carrying a rotation spindle 6 about which a catch 7 revolves. The catch is held in extension by an elastic means such as a spring 8 which tends to move it away from the body of the support 2, in such a way that it interferes with the travel of a mobile abutment 9, itself rotating about the rotation spindle 4. The catch 7 presents a face oriented radially with respect to the rotation spindle 4 so as to offer, in one direction of rotation, a bearing face for the mobile abutment 9 and, in the opposite direction of rotation, an inclined face on which the mobile abutment of the actuator can slip so as to compress the spring 8 and repel the catch 7 away from its travel.

The mobile abutment 9 is carried by a collar 10 of a rotary actuator, not represented, rotating about the rotation spindle 4, and functions as a means of coupling between the collar 10 and the support 2. It is capable of rotating in both directions of rotation and of performing a complete revolution in order to take up any position that may be desired by the operator.

FIG. 2 depicts the phase of selecting the reflector 1 and its deployment from its storage position to the deployed position, with the aid of the mobile abutment 9 and of the catch 7 partnered with the reflector 1.1, which will be dubbed hereinafter 7.1.

FIG. 3 depicts the phases of retraction of the reflector 1 and simultaneous deployment of the three reflectors 1.1, 1.2 and 1.3 by the mobile abutment 9 and its action on the three catches 7.1, 7.2 and 7.3.

In order not to produce mechanical interference between the various elements the invention provides that the fixed abutments 3 as well as the supports 2 do not move in the same planes.

The reflectors are furthermore furnished with inter-reflector partner abutments (not represented in the figures) positioned on the reflectors or on the supports which drive them. The partner abutment fixed to a first reflector driven by the mobile abutment, makes it possible to drive in rotation, either directly or by way of second partner abutments, second reflectors, not selected by the mobile abutment but which are situated downstream of the selected reflector, in the direction of driving by the mobile abutment 9.

In the basic configuration of the invention, which corresponds to FIG. 3, the sizes of the three reflectors 1.1, 1.2 and 1.3 are such that they interfere mechanically with one another. The reflector 1.3 can then be deployed only by also deploying the reflectors 1.1 and 1.2.

The invention can also be implemented with reflectors which do not interfere mechanically with one another. It is then possible to perform selective deployments and retractions of the various reflectors. In this configuration the inter-reflector partner abutments are retractable on operator command, so as to be able either to engage a reflector placed downstream of the selected reflector or not to engage it and leave it in the storage position. A combination on the positions of activation or deactivation of the inter-reflector partner abutments is within the scope of a person skilled in the art so as to find the configuration where only the relevant reflectors will be actuated by the mobile abutment 9.

The conduct of the operations leading to the deployment of a single reflector, such as the reflector 1, will now be described, starting from its storage position, with reference to the phases depicted in FIG. 2.

In the initial situation represented by FIG. 2a the reflectors are in the storage position and the supports 2.1, 2.2 and 2.3 bear against their respective fixed abutments 3.1, 3.2 and 3.3, under the action of their restoring mechanisms. The mobile abutment 9 is initially in an arbitrary radial position on the collar 10. In order to select the reflector 1.1, the operator triggers a rotation of the collar 10 in the direction corresponding to the free passage of the mobile abutment 9 through the catches 7 (anti-clockwise direction such as represented in FIG. 2b). He rotates the collar 10 until the mobile abutment 9 passes the catch 7.1 but does not pass the catches 7.2 and 7.3, as indicated in FIG. 2c. He thereafter triggers a rotation of the collar 10 in the opposite direction to the former, that is to say the clockwise direction such as represented in FIG. 2d, thereby causing the mobile abutment 9 to abut on the radial face of the catch 7.1 and causing the support 2.1 and the reflector 1.1 to be rotated round to the desired position. The reflector is thereafter held in this position by the mobile abutment 9 and the collar 10, which oppose the action of the restoring mechanism which would tend to return this reflector to its fixed abutment 3.1.

When the operator wishes to fold back the reflector 1 he merely needs to rotate the collar 10 in the anti-clockwise direction so that, under the action of the restoring mechanism, the reflector reassumes its storage position. The mobile abutment 9 can thereafter, by still rotating in the same direction, pass through the supports 2.2 and 2.3 while turning aside their catches 7 by bearing on the corresponding inclined faces, and thus reassume the position that it had before the operation.

The conduct of the operations leading to the deployment of several reflectors, such as the reflectors 1, 2 and 3, will now be described, starting from the position of deployment of the reflector 1, and referring to the phases depicted in FIG. 3.

Starting from the position of the deployed reflector 1 as indicated in FIG. 3a, the operator triggers the retraction of this reflector as described above by rotating the collar 10 in the anti-clockwise direction and causes the mobile abutment 9 to pass through the catches of the two supports 2.2 and 2.3. He thereafter reverses the direction of rotation of the collar 10 until the mobile abutment 9 is brought to bear on the radial face of the catch 7.3. Continued rotation of the collar then drives the rotation of the reflector 1.3 towards its deployed position, in which it will remain, held in place by the opposite actions of the mobile abutment 9 and of the restoring mechanism for the reflector 1.3.

On account of the inter-reflector partner abutments which exist between the reflector 1.3 and the two reflectors 1.1 and 1.2, the rotation of the support 2.3 rotates the supports 2.1 and 2.2 and therefore gives rise to the deployment of the reflectors 1.1 and 1.2.

The device presented makes it possible to deploy the reflectors 1.1 alone, 1.1 in combination with 1.2, or 1.1 in combination with 1.2 and 1.3, that is to say a reflector together with all those which are situated downstream of it, through a simple control regarding the angle of rotation of the collar 10. In the variant mentioned above where the operator is afforded the possibility of putting the inter-reflector partner abutments in place or retracting them it becomes possible with the mobile abutment 9 to deploy only the combination of desired reflectors.

In a variant of the invention the mobile abutment 9 is replaced with a catch fixed to the collar 10 of the actuator. The mobile catches 7 of the supports 2 are in this case replaced with abutments tied to the support 2. It is then the catch situated on the collar which is able to turn aside during a rotation of the collar so as to pass under the abutments tied to the supports of the reflectors.

In this variant, it is also conceivable to provide for the actuator to be releasable so that it can be isolated from the collar of the actuator. A second actuator, likewise releasable, is then introduced, so as to impart a redundancy to this space system.

Although the invention has been described in relation to several particular embodiments, it is indeed obvious that it is in no way limited thereto and that it comprises all the technical equivalents of the means described as well as their combinations if the latter enter within the framework of the invention.

1. A device for deploying and retracting appendages of space systems comprising at least two supports each carrying an appendage to be deployed, which is mobile about a rotation spindle, and an actuator furnished with a collar driving the said supports in rotation by way of a coupling means and the said coupling means is able in one direction of rotation to cooperate with each support so as to drive the said support in rotation and to not cooperate with the said supports in the opposite direction of rotation.

2. The deployment and retraction device according to claim 1 in which the coupling means is a mobile abutment presenting a face oriented radially with respect to the rotation spindle and a face inclined with respect to the said radial orientation and in which each support carries a catch extending radially under the action of an elastic means so as to interfere with the travel of the mobile abutment.

3. The deployment and retraction device according to claim 1 in which each support carries an abutment and in which the coupling means is a catch presenting a face oriented radially with respect to the rotation spindle and a face inclined with respect to the said radial orientation and extending radially under the action of an elastic means so as to interfere with the travel of the said abutment.

4. The deployment and retraction device according claim 1 in which each support is permanently urged in rotation towards a fixed abutment in a direction reverse to that of driving by the coupling means.

5. The deployment and retraction device according to claim 4 in which the fixed abutments and also the supports do not move in the same planes.

6. The deployment and retraction device according to claim 1 in which the appendages or supports carry at least one partner abutment fixed to a first appendage or support and capable of interfering with the travel of a second appendage or support so as to drive this second appendage or support during the driving of the said first appendage or support by the coupling means.

7. The deployment and retraction device according to claim 6 in which the partner abutment can be drawn back under the control of the operator so as to be able either to engage an appendage placed downstream of the selected appendage or not to engage it and to leave it in the storage position.

8. The deployment and retraction device according to claim 7 in which the actuator is releasable so as to be able to isolate it from the collar of the actuator, and in which the device comprises a second releasable actuator for affording redundancy to the space system.

9. A deployment and retraction device for an appendage of a space system comprising at least one support carrying an appendage to be deployed, which is mobile about a rotation spindle, and an actuator furnished with a collar driving said support in rotation by way of a coupling means and said coupling means is suitable in one direction of rotation for cooperating with the support so as to drive said support in rotation and for not cooperating with said support in the opposite direction of rotation and:
in which the coupling means is a mobile abutment presenting a face oriented radially with respect to the rotation spindle and a face inclined with respect to said radial orientation and in which each support carries a catch extending radially under the action of an elastic means so as to interfere with the travel of the mobile abutment;
or in which each support carries an abutment and in which the coupling means is a catch presenting a face oriented radially with respect to the rotation spindle and a face inclined with respect to said radial orientation and extending radially under the action of an elastic means so as to interfere with the travel of said abutment.
